(19) United States
(12) Patent Application Publication
(10) Pub. No.: US 2020/0097582 A1
(43) Pub. Date: Mar. 26, 2020

(54) MANAGING ACCESS TO REMOVABLE STORAGE MEDIA USING ARTIFICIAL INTELLIGENCE

(71) Applicant: CA, Inc., Islandia, NY (US)

(72) Inventor: Vlastimil Jedek, Prague (CZ)

(73) Assignee: CA, Inc., Islandia, NY (US)

(21) Appl. No.: 16/142,879

(22) Filed: Sep. 26, 2018

(51) Int. Cl. G06F 17/30; G06F 3/06; G06N 99/00; G06N 3/08

(52) U.S. Cl. CPC G06F 17/30395; G06F 3/0604; G06N 3/08; G06F 3/0682; G06N 99/005; G06F 3/0632

(57) ABSTRACT

In one embodiment, a query history is accessed, wherein the query history comprises information associated with one or more past queries for data stored on a plurality of removable storage mediums. A machine learning model is trained for query prediction based on the query history. A future query is predicted based on the machine learning model, wherein the future query comprises an indication of a first dataset that is predicted to be queried at a future point in time, wherein the first dataset comprises a subset of the data stored on the plurality of removable storage mediums. A first removable storage medium containing the first dataset is identified, wherein the first removable storage medium is identified from the plurality of removable storage mediums. A storage drive is configured for access to the first removable storage medium at the future point in time.

### BACKGROUND

This disclosure relates in general to the field of data processing and storage, and more particularly, though not exclusively, to data access management for removable storage media.

Large enterprises, such as businesses and other organizations, typically generate and consume massive volumes of data throughout the ordinary course of business. These enterprises must be capable of processing and storing large volumes of data in an efficient manner that is conducive to both on-demand access as well as long-term retention. Due to the sheer volume of data and lengthy data retention policies of many enterprises, much of their data is often stored on removable storage media, such as magnetic tapes, optical discs, and so forth. While these types of removable storage are often cost-efficient solutions for storing large volumes of data, they typically have high latency and slow access times.

### BRIEF SUMMARY

According to one aspect of the present disclosure, a query history is accessed, wherein the query history comprises information associated with one or more past queries for data stored on a plurality of removable storage mediums. A machine learning model is trained for query prediction based on the query history. A future query is predicted based on the machine learning model, wherein the future query comprises an indication of a first dataset that is predicted to be queried at a future point in time, wherein the first dataset comprises a subset of the data stored on the plurality of removable storage mediums. A first removable storage medium containing the first dataset is identified, wherein the first removable storage medium is identified from the plurality of removable storage mediums. A storage drive is configured for access to the first removable storage medium at the future point in time.

### BRIEF DESCRIPTION OF THE DRAWINGS

FIG. 1 illustrates an example embodiment of a computing system for managing access to removable storage media using artificial intelligence.

FIG. 2 illustrates an example embodiment of a data storage system with predictive removable storage access.

FIG. 3 illustrates an example of query prediction for predictive removable storage access.

FIG. 4 illustrates a flowchart for an example embodiment of predictive removable storage access.

### DETAILED DESCRIPTION OF EXAMPLE EMBODIMENTS

As will be appreciated by one skilled in the art, aspects of the present disclosure may be illustrated and described herein in any of a number of patentable classes or contexts, including any new and useful process, machine, manufacture, or composition of matter, or any new and useful improvement thereof. Accordingly, aspects of the present disclosure may be implemented entirely as hardware, entirely as software (including firmware, resident software, micro-code, etc.), or as a combination of software and hardware implementations, all of which may generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider), or in a cloud computing environment, or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices, to produce a computer implemented process such that the instructions which execute on the computer or other programmable apparatus provide processes for implementing the functions/acts specified in the flowchart and/or block diagram block or blocks.

Example embodiments that may be used to implement the features and functionality of this disclosure will now be described with more particular reference to the attached FIGURES.

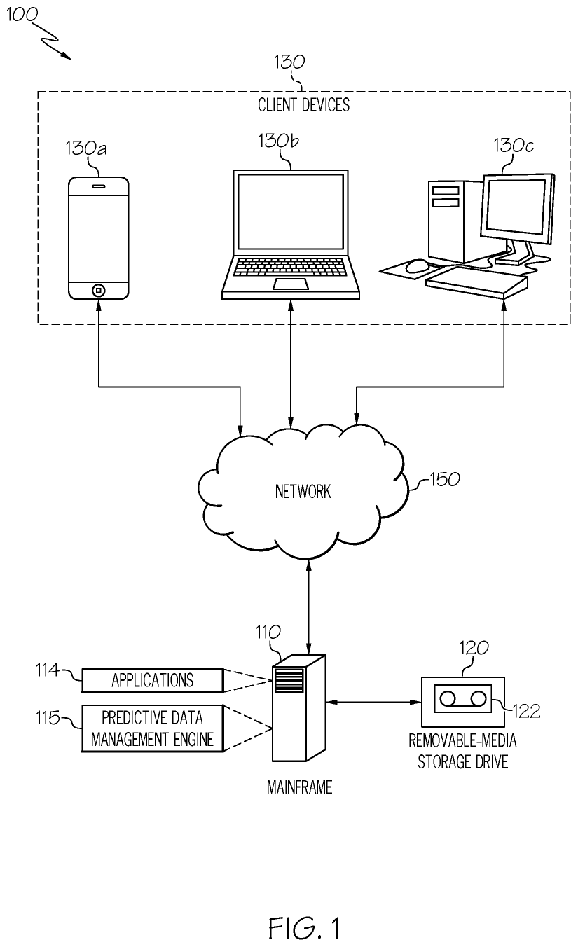

FIG. 1 illustrates an example embodiment of a computing system 100 for managing access to removable storage media using artificial intelligence. In the illustrated embodiment, for example, system 100 includes a predictive data management engine 115 that uses machine learning to predict future access to data stored on removable storage media 122, thus enabling a storage drive 120 to be proactively configured to provide access to the appropriate storage media 122 at the appropriate time, as described further below.

Large enterprises, such as businesses and other organizations, typically generate and/or consume massive volumes of data throughout the ordinary course of business. For example, a business often runs a variety of computing applications that are designed to facilitate or streamline regular business operations, such as applications that provide certain services for the benefit of customers, employees, and/or the business itself. These types of computing applications generally involve large volumes of data, such as data that is consumed by the applications in order to function properly and/or data that is generated throughout the course of their operation.

Accordingly, an enterprise must be capable of continuously receiving and processing a large volume of queries from the various sources that may need access to certain data or reports, such as applications, system administrators, employees, customers, and so forth. In particular, numerous reports associated with the data maintained by a large enterprise are often requested and/or generated on a regular basis. For example, a public corporation may generate various financial or performance reports at the end of each quarter for legal compliance purposes or for the benefit of its shareholders, such as a quarterly earnings report. A bank or financial institution may generate periodic reports for its customers, such as monthly bank account statements, quarterly stock statements, pension statements, and so forth. A retail company may generate sales reports for each of its stores on a frequent basis (e.g., daily, weekly, or monthly), and may further consolidate the reports for different geographic regions on a less frequent basis for review by regional sales managers. Many companies also generate payroll reports for their employees in connection with every pay period (e.g., bi-weekly, monthly).

As the volume and importance of enterprise data continues to grow, mainframe computing is often leveraged for these high-volume data processing tasks, such as generating reports, managing access to data (e.g., storage, retrieval, query processing, backup and archiving), and so forth. For example, enterprises often rely on mainframe computing to generate reports associated with massive volumes of data that must be processed on a daily basis. Moreover, this data is often preserved or retained by enterprises for long periods of time, which may be dictated based on internal data retention policies, legal or regulatory requirements, and so forth.

Accordingly, enterprises must be capable of processing and storing large volumes of data in an efficient manner that is conducive to both on-demand access as well as long-term retention. While frequently accessed data that must remain readily available may be stored using low-latency random-access storage (e.g., random-access memory (RAM), solid-state storage), long-term storage of large volumes of data is often provided using removable storage media, such as magnetic tapes and/or optical discs. These types of removable storage are relatively inexpensive and provide a more cost-efficient solution for long-term storage, particularly in view of the sheer volume of data and lengthy data retention policies of many enterprises. Removable storage typically has higher data access latency, however, as the underlying storage media must be mechanically manipulated and requires data to be accessed sequentially.

A tape drive, for example, is a device used to access data stored on magnetic tape cartridges. In order to read certain data from a particular tape cartridge, the tape cartridge must be physically loaded into a tape drive, and the tape drive can then sequentially access the underlying data by mechanically manipulating the magnetic tape within the tape cartridge. Some tape drives may require tape cartridges to be manually loaded (e.g., by a system administrator), while others (e.g., mainframe-class tape drives) may be implemented within or in conjunction with autoloaders that automate the handling of tape cartridges. An autoloader, which may also be referred to as a tape library or tape silo, may be a robotic device with a library of tape cartridges that can be automatically loaded into one or more tape drives. Moreover, each tape drive may be capable of having one or more tape cartridges loaded at any given time. In this manner, tape cartridges may be continuously swapped in and out of a tape drive whenever data stored on other tape cartridges needs to be accessed.

As an example, when a query requesting certain data and/or a report associated with that data is received, the particular tape cartridge(s) containing the responsive data must be physically loaded into a tape drive (e.g., manually by a system administrator or automatically by an autoloader), which may first require any currently loaded tape cartridge(s) in the tape drive to be swapped out. The tape drive then sequentially accesses the magnetic tape within the appropriate tape cartridge in order to retrieve the desired data. Accordingly, the access latency of magnetic tape storage is often very high, particularly when the appropriate tape cartridge is not already loaded in the tape drive at the time of access.

Accordingly, in the illustrated embodiment, computing system 100 uses artificial intelligence to manage access to removable storage media more efficiently, thus reducing access latency and administrative burdens while improving overall performance. In the illustrated embodiment, for example, computing system 100 includes mainframe 110, removable-media storage drive 120, client devices 130a-c, and network 150. Mainframe 110 includes one or more applications 114 and a predictive data management engine 115, which may be executed on one or more processors within the mainframe. Mainframe 110 is also communicatively coupled to a removable-media storage drive 120, which may be used to access or store data on removable storage media 122, such as a tape drive that accesses and stores data on tape cartridges. Further, mainframe 110 is connected to a network 150 in order to communicate with other components of system 100, such as client devices 130a-c. Client devices 130a-c may include any type of device that communicates or interacts with mainframe 110, including mobile devices, laptops, desktops, kiosks, and/or other mainframes or datacenter servers.

Predictive data management engine 115 manages access to data stored on storage drive 120, such as data that is requested or queried by applications 114 and/or client devices 130. In particular, predictive data management engine 115 uses predictive analytics or modeling (e.g., machine learning) to predict future access to data stored on removable storage media 122, thus enabling storage drive 120 to be proactively configured to provide access to the appropriate storage media 122 at the appropriate time.

In some embodiments, for example, a query history or log of past queries and reports associated with data stored on removable storage media 122 may be maintained, and the query history may be used to train a machine learning model to predict future queries associated with that data. For example, the query history may include a log of a variety of information associated with each past query, such as the query time and date (e.g., time of day, day of week, day of month, month, year), the type of data or report requested by the query (including the scope or granularity of the requested data), the source of the query (e.g., a particular application 114, client device 130, system administrator, employee, customer), the underlying physical storage medium (e.g., the general type of storage and/or the specific article of removable storage containing the data, such as a particular tape or disc), and/or any other parameter or attribute associated with the query.

A predictive model can then be designed and/or trained to make predictions based on patterns identified from the past queries in the query history, such as patterns relating to the query time (also known as time-series predictions) (e.g., time of day, day of week, day of month, month of year, time of year or season), the type/scope/granularity of the requested data or report, the requesting source, the underlying physical storage medium, related queries, and/or any other attribute or parameter of past queries that is tracked in the query history. In various embodiments, for example, time-series and/or other predictions may be performed using any suitable type of predictive analytics or modeling, including any of the following forms of machine learning, pattern recognition, and/or statistical analysis: an artificial neural network (ANN), such as a recurrent neural network (RNN) (e.g., a long short-term memory (LSTM) network or RNN); an autoregressive moving average (ARMA) or autoregressive integrated moving average (ARIMA) model; and/or a regression analysis model.

In some embodiments, for example, a machine learning model may be designed and/or trained to predict future queries based on the query history. For example, the past queries in the query history may serve as ground truth training data used to train the machine learning model. Moreover, based on patterns identified in the past queries, the machine learning model may then predict potential future queries. For example, the machine learning model may identify a pattern of past queries for a certain type of data or report that is periodically requested at or around a particular date and/or time. Accordingly, the machine learning model may predict that a future query for that type of data or report may be received at a particular date and/or time in the future. The predicted future query generated by the machine learning model may indicate a predicted query time (e.g., time of day, day of week, day of month, month, year) and the particular data or report that will be requested by the query, along with any other attributes or parameters associated with the query.

As another example, the machine learning model may identify a pattern of related queries or reports that are typically requested together. In some cases, for example, a particular set of queries or reports may be requested at irregular or random times, but they may be consistently requested together (e.g., at or around the same time or within a certain amount of time relative to each other). Accordingly, when a query for one of the related reports is received, the machine learning model may predict that queries for the other related reports will be received shortly or within a certain amount of time. For example, the prediction model may determine that when report A is requested, that request is typically followed by requests for related reports B and C (e.g., thus enabling the appropriate storage media 122 for reports B and C to be proactively loaded into storage drive 120 and mounted).

In this manner, the predicted future queries can be used to proactively configure storage drive 120 to provide access to the appropriate removable storage media 122 at the appropriate time. For example, based on a predicted future query, the particular removable storage medium(s) 122 containing the responsive data can be identified, loaded into the storage drive 120, and configured for access (e.g., mounted by an operating system) in advance of the predicted query time.

With respect to magnetic tape storage, for example, the particular tape cartridge(s) 122 containing responsive data can be identified, loaded into one or more tape drives 120 (e.g., by an autoloader, tape silo, and/or tape library), and mounted on the file system of an operating system (O/S) executing on the mainframe 110. In some cases, the data may be further loaded from the tape cartridge(s) 122 into low-latency and/or random-access memory to provide faster access, such as a local cache on the mainframe 110 or on the tape drive 120. In this manner, if and when an actual query corresponding to the predicted future query is received, the responsive data stored on the tape cartridge(s) 122 will be readily available, thus reducing the response time associated with responding to the actual query.

Further, the predictive model can be continuously optimized or updated based on the actual queries that are received and processed during live operation (e.g., similar to how the predictive model was initially trained using the past queries in the query history). For example, a predictive machine learning model can treat the actual queries as ground truth training labels in order to optimize the existing query predictions and/or learn or identify new query predictions. In some cases, for example, if an actual query is received that fully matches a predicted query, the machine learning model may validate or reinforce the predicted query, such as by increasing a confidence level associated with the predicted query. If the actual query only partially matches a predicted query, however, the machine learning model may tailor or adjust certain aspects of the predicted query, such as the time, type of data, scope, and/or granularity of the predicted query. Moreover, if one or more actual queries are received that do not match any of the existing query predictions (e.g., a missed prediction), the machine learning model may learn or identify a new query prediction based on patterns associated with those actual queries. Finally, if no actual queries are received for a particular predicted query (e.g., a false prediction), the machine learning model may determine that the prediction was incorrect and may either discard the predicted query and/or decrease its associated confidence level.

Additional details and embodiments associated with predictive access management for removable storage are described throughout this disclosure in connection with the remaining FIGURES.

In general, elements of computing system 100, such as “systems,” “servers,” “mainframes,” “devices,” “clients,” “networks,” “computers,” and any components thereof, may be used interchangeably herein and refer to computing devices operable to receive, transmit, process, store, or manage data and information associated with computing system 100. Moreover, as used in this disclosure, the term “computer,” “processor,” “processor device,” or “processing device” is intended to encompass any suitable processing device. For example, elements shown as single devices within computing system 100 may be implemented using a plurality of computing devices and processors, such as server pools comprising multiple server computers. Further, any, all, or some of the computing devices may be adapted to execute any operating system, including Linux, other UNIX variants, Microsoft Windows, Windows Server, Mac OS, Apple iOS, Google Android, etc., as well as virtual machines adapted to virtualize execution of a particular operating system, including customized and/or proprietary operating systems.

Moreover, elements of computing system 100 (e.g., mainframe 110, storage drive 120, client devices 130a-c, network 150, and so forth) may each include one or more processors, computer-readable memory, and one or more interfaces, among other features and hardware. Servers and mainframes may include any suitable software component or module, or computing device(s) capable of hosting and/or serving software applications and services, including distributed, enterprise, or cloud-based software applications, data, and services. For instance, one or more of the described components of computing system 100, may be at least partially (or wholly) cloud-implemented, “fog”-implemented, web-based, or distributed for remotely hosting, serving, or otherwise managing data, software services, and applications that interface, coordinate with, depend on, or are used by other components of computing system 100. In some instances, elements of computing system 100 may be implemented as some combination of components hosted on a common computing system, server, server pool, or cloud computing system, and that share computing resources, including shared memory, processors, and interfaces.

Further, the network(s) 150 used to communicatively couple the components of computing system 100 may be implemented using any suitable computer communication or network technology for facilitating communication between the participating components. For example, one or a combination of local area networks, wide area networks, public networks, the Internet, cellular networks, Wi-Fi networks, short-range networks (e.g., Bluetooth or ZigBee), and/or any other wired or wireless communication medium may be utilized for communication between the participating devices, among other examples.

While FIG. 1 is described as containing or being associated with a plurality of elements, not all elements illustrated within computing system 100 of FIG. 1 may be utilized in each alternative implementation of the embodiments of this disclosure. Additionally, one or more of the elements described in connection with the examples of FIG. 1 may be located external to computing system 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

Additional embodiments and functionality associated with the implementation of computing system 100 are described further in connection with the remaining FIGURES. Accordingly, it should be appreciated that computing system 100 of FIG. 1 may be implemented with any aspects or functionality of the embodiments described throughout this disclosure.

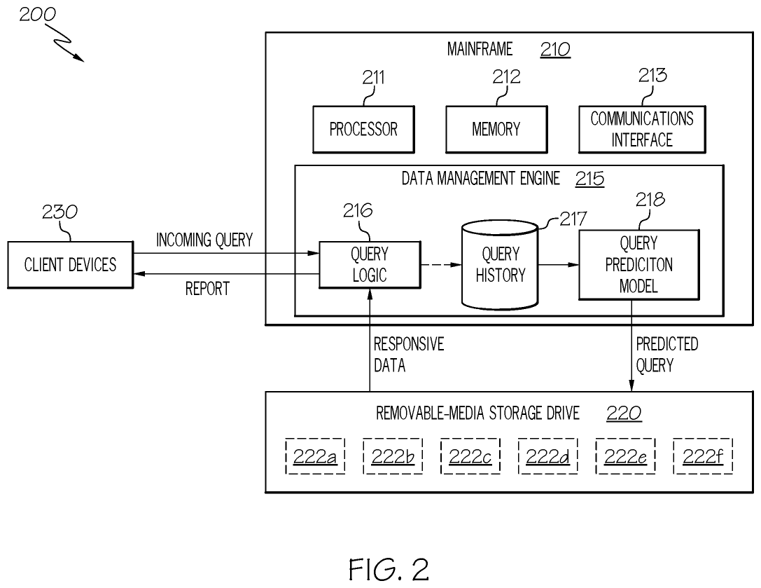

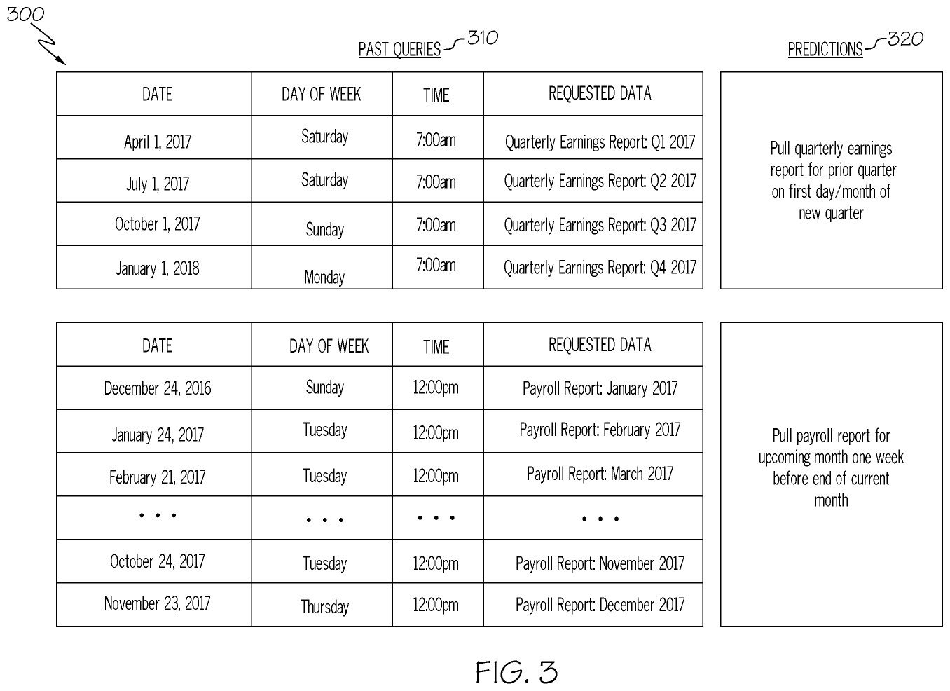

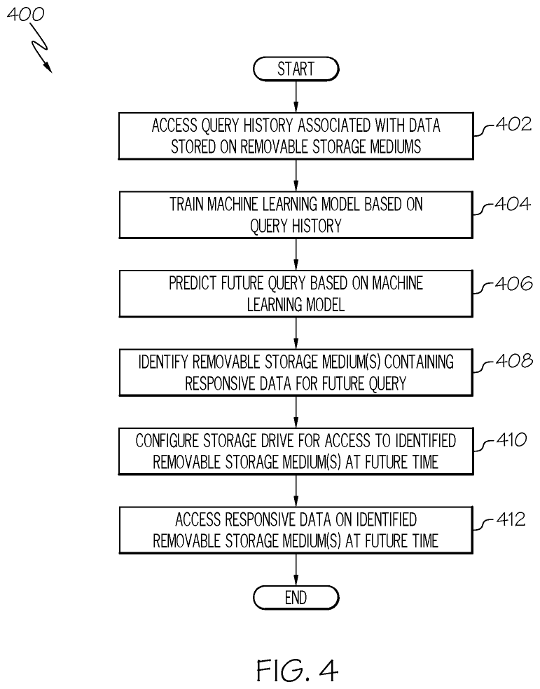

FIG. 2 illustrates an example embodiment of a data storage system 200 with predictive removable storage access. In various embodiments, for example, data storage system 200 may be used to implement the predictive removable storage access functionality described throughout this disclosure (e.g., the functionality described in connection with computing system 100 of FIG. 1, example 300 of FIG. 3, and/or flowchart 400 of FIG. 4). In the illustrated embodiment, data storage system 200 includes a mainframe 210, a removable-media storage drive 220, and client devices 230, as described further below.

Mainframe 210 includes a processor 211, a memory 212, a communication interface 213, and a data management engine 215. Processor 211 may be used to execute logic and/or instructions stored in memory 212, such as the logic and/or instructions used to implement data management engine 215. Communication interface 213 may be used to communicate with external systems and components, such as client devices 230 and/or other devices or applications. Data management engine 215 may include any suitable combination of logic and/or instructions for managing access to data stored on removable-media storage drive 220, as described further below.

Removable-media storage drive 220 may be any type of storage drive used to access data stored on removable storage media 222a-f. In some embodiments, for example, storage drive 220 may be a tape drive used to access data stored on magnetic tape cartridges 222a-f.

Client devices 230 may include any type of device, component, and/or application that communicates or interacts with mainframe 210. In some cases, for example, client devices 230 may send queries to mainframe 210 requesting certain data and/or reports that are stored on removable storage media 222.

Data management engine 215 is used process queries that mainframe 210 receives from client devices 230. In the illustrated embodiment, for example, data management engine 215 includes query processing logic 216, a query history 217, and a query prediction model 218. Query processing logic 216 receives, processes, and/or responds to incoming queries received from client devices 230; query history 217 contains a log of all past queries received from client devices 230; and query prediction model 218 predicts future queries based on the query history 217. In various embodiments, for example, query prediction model 218 may be implemented using any suitable type of predictive analytics or modeling, such as machine learning. Moreover, query prediction model 218 may be designed to predict future queries based on patterns identified from the past queries tracked in the query history 217. The predicted future queries can then be used to proactively configure the storage drive 220 to provide access to the appropriate removable storage media 222a-f containing responsive data associated with the predicted queries. For example, based on a predicted future query, a tape storage drive 220 may be proactively loaded with the particular magnetic tape cartridge(s) 222 containing responsive data in advance of the predicted query time. In this manner, when an incoming query corresponding to the predicted query is subsequently received, the responsive data stored on the removable storage media 222 will be readily accessible and can be quickly retrieved from the storage drive 220 by the query processing logic 216. Further, the query processing logic 216 can update the query history 217 as incoming queries are received, and the query prediction model 218 can continuously optimize its predictions based on the latest query history 217.

In some implementations, the various illustrated components of data storage system 200, and/or any other associated components, may be combined, or even further divided and distributed among multiple different systems. For example, in some implementations, mainframe 210, data storage engine 215, and/or storage drive 220 may be integrated together as part of a single component, device, or system, or alternatively may be distributed across multiple distinct components, devices, or systems that respectively include varying combinations of the underlying illustrated components.

FIG. 3 illustrates an example 300 of query prediction for predictive removable storage access. In particular, the illustrated example depicts various predictions 320 that are derived from past queries 310 using the embodiments and functionality described throughout this disclosure. For example, based on past queries for quarterly earnings reports, it is predicted that quarterly earnings reports for the prior quarter will be pulled on the first day of the month of each new quarter. Similarly, based on past queries for payroll reports, it is predicted that payroll reports for each upcoming month will be generated and/or pulled one week before the end of the current month. Accordingly, these predictions may be used to proactively manage access to removable storage media that is used to store the responsive data, as described further throughout this disclosure.

FIG. 4 illustrates a flowchart 400 for an example embodiment of predictive removable storage access. In some embodiments, flowchart 400 may be implemented using the embodiments and functionality described throughout this disclosure (e.g., computing system 100 of FIG. 1 and/or data storage system 200 of FIG. 2).

The flowchart may begin at block 402, where a query history associated with data stored on a plurality of removable storage mediums is accessed. In some embodiments, for example, the data may be stored on a library or collection of tape cartridges accessible via a tape drive. Moreover, the query history may include various types of information associated with one or more past queries for the data. For example, for each past query, the query history may indicate the query time and date (e.g., time of day, day of week, day of month, month, year), the type of data or report requested by the query (including the scope or granularity of the requested data), the source of the query (e.g., a particular application, client device, system administrator, employee, customer), the underlying physical storage medium (e.g., the general type of storage and/or the specific article of removable storage containing the data, such as a particular tape cartridge), and/or any other parameter or attribute associated with the query.

The flowchart may then proceed to block 404, where a machine learning model is trained for query prediction based on the query history. In some embodiments, for example, a machine learning model may be designed and/or trained to predict future queries using time-series predictions derived from the query history. For example, the past queries in the query history may serve as ground truth training data used to train the machine learning model. Moreover, based on patterns identified in the past queries, the machine learning model may then predict potential future queries. For example, the machine learning model may identify a pattern of past queries for a certain type of data or report that is periodically requested at or around a particular date and/or time. Accordingly, the machine learning model may predict that a future query for that type of data or report may be received at a particular date and/or time in the future. The future query predicted by the machine learning model may indicate a predicted query time (e.g., time of day, day of week, day of month, month, year) and the particular data or report to be requested by the query, along with any other attributes or parameters associated with the query.

In various embodiments, the machine learning model used for these time-series predictions may be implemented using an artificial neural network (ANN) model (such as a recurrent neural network (RNN), or more specifically, a long short-term memory (LSTM) network or RNN), an autoregressive moving average (ARMA) or autoregressive integrated moving average (ARIMA) model, a regression model, and/or any other suitable type of predictive, machine learning, and/or artificial intelligence model.

The flowchart may then proceed to block 406, where a future query is predicted based on the machine learning model. For example, based on the query history used to train the machine learning model, the machine learning model may predict that a particular future query will be subsequently received. The predicted future query, for example, may indicate a particular dataset that is predicted to be queried at a future point in time. In various embodiments, the predicted future query may identify the particular dataset either directly or indirectly (e.g., based on query parameters). Moreover, the particular dataset may be a subset of the data stored on the plurality of removable storage mediums.

The flowchart may then proceed to block 408, where the particular removable storage medium(s) containing the responsive dataset for the predicted future query are identified from the plurality of removable storage mediums. In some embodiments, for example, the specific tape cartridge(s) containing the responsive dataset may be identified from the library or collection of tape cartridges.

The flowchart may then proceed to block 410, where a storage drive is configured for providing access to the identified removable storage medium(s) at the future point in time associated with the predicted query.

In some embodiments, for example, a tape drive may be proactively configured to provide access to the identified tape cartridge(s) at the predicted query time. For example, a processor, mainframe, and/or data management engine may cause the particular tape cartridge(s) containing the responsive dataset to be loaded into the tape drive (e.g., by an autoloader, tape silo, and/or tape library) and configured for access (e.g., mounted onto the file system of an associated operating system) in advance of the predicted query time. In this manner, the tape drive is ready to provide access to the tape cartridge(s) at or before the predicted query time. In this manner, if and when an actual query corresponding to the predicted future query is received, the responsive dataset stored on the tape cartridge(s) will be readily available, thus reducing the response time associated with responding to the actual query.

The flowchart may then proceed to block 412, where the responsive dataset is accessed or retrieved from the identified removable storage medium(s) via the storage drive. In some embodiments, for example, once an actual incoming query corresponding to the predicted query is received, the tape drive may be accessed in order to retrieve the responsive dataset from the appropriate tape cartridge(s). Alternatively, the responsive dataset may be retrieved from the tape cartridge(s) and loaded into low-latency memory (e.g., a local cache of a processor, mainframe, and/or tape drive) in advance of the predicted query time, and the dataset may be subsequently retrieved from the low-latency memory once the corresponding incoming query is received. The retrieved dataset can then be used to respond to the incoming query.

Further, in some embodiments, incoming queries may be used to optimize the predictions generated by the machine learning model. For example, an incoming query (or a lack thereof) may be used to determine whether a future query was successfully predicted by the machine learning model. If an incoming query is received that fully matches a predicted future query, then it may be determined that the future query was predicted correctly. If the incoming query only partially matches the predicted future query, then the prediction may be tailored or adjusted, as appropriate. If no incoming query is ever received for a predicted future query (e.g., an actual query corresponding to the future query is not received at or around the predicted future point in time), it may be determined that the future query was predicted incorrectly. Accordingly, the machine learning model may optimize its predictions based on these incoming queries (or lack thereof).

At this point, the flowchart may be complete. In some embodiments, however, the flowchart may restart and/or certain blocks may be repeated. For example, in some embodiments, the flowchart may restart at block 402 to continue predicting future queries and configuring access to the appropriate removable storage media.

It should be appreciated that the flowcharts and block diagrams in the FIGURES illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or alternative orders, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as suited to the particular use contemplated.

1. A method, comprising:
accessing a query history, wherein the query history comprises information associated with one or more past queries for data stored on a plurality of removable storage mediums;
training a machine learning model for query prediction based on the query history;
predicting a future query based on the machine learning model, wherein the future query comprises an indication of a first dataset that is predicted to be queried at a future point in time, wherein the first dataset comprises a subset of the data stored on the plurality of removable storage mediums;
identifying a first removable storage medium containing the first dataset, wherein the first removable storage medium is identified from the plurality of removable storage mediums; and
configuring a storage drive for access to the first removable storage medium at the future point in time.

2. The method of claim 1, wherein:
the storage drive comprises a tape drive; and
the plurality of removable storage mediums comprises a plurality of tape cartridges.

3. The method of claim 1, wherein configuring the storage drive for access to the first removable storage medium at the future point in time comprises:
causing the first removable storage medium to be loaded into the storage drive prior to the future point in time.

4. The method of claim 1, further comprising:
receiving an incoming query corresponding to the future query that was predicted;
accessing the storage drive to retrieve the first dataset from the first removable storage medium; and
responding to the incoming query based on the first dataset.

5. The method of claim 1, further comprising:
receiving an incoming query associated with the data stored on the plurality of removable storage mediums; and
optimizing the machine learning model for query prediction based on the incoming query.

6. The method of claim 5, wherein optimizing the machine learning model for query prediction based on the incoming query comprises:
determining whether the incoming query was predicted successfully based on the machine learning model; and
optimizing the machine learning model for query prediction based on whether the incoming query was predicted successfully.

7. The method of claim 1, further comprising:
determining that the future query was predicted incorrectly; and
optimizing the machine learning model based on determining that the future query was predicted incorrectly.

8. The method of claim 7, wherein determining that the future query was predicted incorrectly comprises:
determining that an actual query corresponding to the future query was not received at the future point in time.

9. The method of claim 1, wherein the machine learning model comprises a recurrent neural network.

10. The method of claim 9, wherein the recurrent neural network comprises a long short-term memory (LSTM) model.

11. The method of claim 1, wherein the machine learning model comprises an autoregressive moving average model.

12. The method of claim 1, wherein the machine learning model comprises a regression model.

13. A non-transitory computer readable medium having program instructions stored therein, wherein the program instructions are executable by a computer system to perform operations comprising:
accessing a query history, wherein the query history comprises information associated with one or more past queries for data stored on a plurality of removable storage mediums;
training a machine learning model for query prediction based on the query history;
predicting a future query based on the machine learning model, wherein the future query comprises an indication of a first dataset that is predicted to be queried at a future point in time, wherein the first dataset comprises a subset of the data stored on the plurality of removable storage mediums;
identifying a first removable storage medium containing the first dataset, wherein the first removable storage medium is identified from the plurality of removable storage mediums; and
configuring a storage drive for access to the first removable storage medium at the future point in time.

14. A system, comprising:
a processing device;
a memory; and
a data management engine stored in the memory, the data management engine executable by the processing device to:
access a query history, wherein the query history comprises information associated with one or more past queries for data stored on a plurality of removable storage mediums;
train a machine learning model for query prediction based on the query history;
predict a future query based on the machine learning model, wherein the future query comprises an indication of a first dataset that is predicted to be queried at a future point in time, wherein the first dataset comprises a subset of the data stored on the plurality of removable storage mediums;
identify a first removable storage medium containing the first dataset, wherein the first removable storage medium is identified from the plurality of removable storage mediums; and
configure a storage drive for access to the first removable storage medium at the future point in time.

15. The system of claim 14, further comprising the storage drive, wherein:
the storage drive comprises a tape drive; and
the plurality of removable storage mediums comprises a plurality of tape cartridges.

16. The system of claim 14, wherein the data management engine executable by the processing device to configure the storage drive for access to the first removable storage medium at the future point in time is further executable to:
cause the first removable storage medium to be loaded into the storage drive prior to the future point in time.

17. The system of claim 14, wherein the data management engine is further executable by the processing device to:
receive an incoming query corresponding to the future query that was predicted;
access the storage drive to retrieve the first dataset from the first removable storage medium; and
respond to the incoming query based on the first dataset.

18. The system of claim 14, wherein the data management engine is further executable by the processing device to:
receive an incoming query associated with the data stored on the plurality of removable storage mediums; and
optimize the machine learning model for query prediction based on the incoming query.

19. The system of claim 18, wherein the data management engine executable by the processing device to optimize the machine learning model for query prediction based on the incoming query is further executable to:
determine whether the incoming query was predicted successfully based on the machine learning model; and
optimize the machine learning model for query prediction based on whether the incoming query was predicted successfully.

20. The system of claim 14, wherein the data management engine is further executable by the processing device to:
determine that an actual query corresponding to the future query was not received at the future point in time;
determine that the future query was predicted incorrectly; and
optimize the machine learning model based on determining that the future query was predicted incorrectly.
